(19) United States
(12) Patent Application Publication
(10) Pub. No.: US 2009/0229708 A1
(43) Pub. Date: Sep. 17, 2009

(54) SYSTEM AND METHOD FOR ENERGY-EFFICIENT ON-SITE PROCESSING OF FORESTRY BRUSHWOOD

(75) Inventor: William D. Quigg, Hoquiam, WA (US)

Correspondence Address: BLACK LOWE & GRAHAM, PLLC, 701 FIFTH AVENUE, SUITE 4800, SEATTLE, WA, 98104, US

(73) Assignee: Barrier West, Inc., Aberdeen, WA (US)

(21) Appl. No.: 12/402,431

(22) Filed: Mar. 11, 2009

Related U.S. Application Data
(60) Provisional application No. 61/035,990, filed on Mar. 12, 2008.

(51) Int. Cl. A01G 23/095; B66C 1/42

(52) U.S. Cl. 144/4.1; 294/106

(57) ABSTRACT

A system to compact brushwood at logging sites and to allow its rapid removal from logging sites is described. The system includes a grappling claw fitted with at least one swivelable or pivotable chainsaw to the side of the grappling claw. The grappling claw pinches a bundle of brushwood and the at least one chainsaw cuts it into bundled sections. Another embodiment includes a grappling claw fitted with two chainsaws, each chainsaw pivotably mounted on each side of the grappling claw and may be adjusted to different inter-chainsaw separations. The pinched brushwood bundle is sawed into bundle sections defined by the distance between the two chainsaws and/or to lengths falling externally from the chainsaws not held by the grappling claw.

### CROSS REFERENCE TO RELATED APPLICATIONS

This application claims priority to and incorporates by reference in its entirety U.S. Provisional Patent Application No. 61/035,990 filed Mar. 12, 2008.

### FIELD OF THE INVENTION

An embodiment of the invention relates generally to more environmentally friendly on-site processing and re-cycling of forestry waste byproducts generated by logging operations.

### BACKGROUND OF THE INVENTION

Removal or processing of slash, brushwood and other wood debris after logwood harvesting from forestry sites presents economical and ecological challenges. It is desirable to have brushwood rapidly removed from a freshly logged site so that tree seedling planting can commence. Low-density brushwood may often not be amenable for efficient removal from logging sites because it cannot be readily compacted and hauled away since it is economically inefficient, that is, too costly for removal operations. In such cases, often unsightly and hazardous slash piles remain long after forestry harvests. In other cases, slash piles are simply burned, increasing carbon emissions, compounding global climate change and without any corresponding offsetting benefits of energy recapture.

By way of example, FIG. 1 illustrates in cross-section of a portion of a trailer 8 in which brushwood is being dropped from a grappling claw 24 attached to an articulating arm 5 operated from a forestry machine (not shown) via cables 42 and hydraulic lines 46. The grappling claw 24 is shown dropping raw brushwood into the trailer 8 as an example of inefficient brushwood removal from a forestry site. Note that the trailer-received brushwood shows a very low density compaction. A substantially random collection of unstacked and disordered brushwood with large interstitial gaps between brushwood pieces is illustrated.

Solutions for brushwood removal have included on-site burning and reduction to on-site wood chip piles. Burning is ecologically wasteful and is prone to cause spreading forest fires. The wood chipping process presents several problems. First, roads in forestry terrains is often impassable, and even when passable, it remains inconvenient and energy inefficient to transport heavy, urban deployed wood chippers along unpaved, uneven logging roads with narrow switchbacks. Second, when brushwood is chipped on site, its sponge like qualities allows it to absorb and retain water during the rainy season and so cannot be used for efficient burning in this soggy state. Third, during the summer months, the wood chips will dry out and present a hazardous fire condition. Being able to have a forestry clearing operation to rapidly remove brushwood and other wood waste byproducts from logging operations to allow rapid tree replanting is a desirable goal to achieve in forestry stewardship.

### BRIEF DESCRIPTION OF THE DRAWINGS

Preferred and alternative examples of the present invention are described in detail below with reference to the following drawings:

FIG. 1 illustrates in cross-section an example of low-density, inefficient brushwood compaction operation;

FIGS. 2-14 below illustrate particular embodiments of systems and methods for energy-efficient on-site processing of forestry brushwood; in particular

FIG. 2 depicts a side perspective view of a sheathed chainsaw mounted on the side of a chainsaw grappling claw operable by a Caterpillar forestry machine;

FIG. 3A depicts a side perspective view of an un-sheathed or deployed chainsaw mounted on the side of the chainsaw grappling claw operable by the CAT forestry machine;

FIG. 3B depicts an alternate embodiment of FIG. 2A having two un-sheathed or deployed chainsaws on opposing sides of the chainsaw grappling claw;

FIG. 4 depicts a side perspective view of the chainsaw grappling claw with an unsheathed chainsaw being positioned to grasp a bundle of forestry brushwood;

FIG. 5 is a side view depicting a portion of an unsheathed chainsaw;

FIG. 6 depicts a front perspective view of a portion of an unsheathed chainsaw undergoing maintenance;

FIG. 7 depicts a side perspective view of a portion of an unsheathed chainsaw undergoing maintenance;

FIG. 8 depicts a front view of the chainsaw grappling claw with sheathed chainsaws in relation to adjacent drive cage;

FIG. 9 depicts a front view of the chainsaw grappling claw with sheathed chainsaws extended to accommodate different length brushwood cuts in relation to adjacent drive cage;

FIG. 10 depicts a side perspective view of a deployed chainsaw grappling claw with sheathed chainsaw being positioned to grasp a bundle of forestry brushwood;

FIG. 11 depicts a side perspective view of a deployed chainsaw grappling claw with unsheathed chainsaw being deployed onto to grappled bundle of forestry brushwood;

FIG. 12 depicts a side perspective view of a deployed chainsaw grappling claw with unsheathed chainsaw deployed to reveal a cut grappled bundle of forestry brushwood;

FIG. 13 depicts a side and side perspective views of deployed chainsaw grappling claws with deploying and deployed unsheathed chainsaws positioned to drop cut brushwood bundles into forestry trailer; and

FIG. 14 depicts a side perspective and cross-sectional view of deployed chainsaw grappling claws with sheathed chainsaws positioned and releasing cut brushwood bundles into the forestry trailer.

### DETAILED DESCRIPTION OF THE PARTICULAR EMBODIMENTS

In an embodiment, a system including a forestry machine modified to perform at least one of compacting, cutting, and loading brushwood onto transports for removal from logging sites is described. The system includes a forestry machine having a chainsaw grappling claw fitted with at least one swivelable or pivotable chainsaw adjacent to the chainsaw grappling claw. The chainsaw grappling claw pinches and/or compacts a bundle of brushwood and the at least one chainsaw cuts it into bundled sections of fixed or adjustably defined lengths. Another embodiment includes a chainsaw grappling claw fitted with two or more chainsaws, each chainsaw pivotably mounted on each side of the chainsaw grappling claw and which may be adjusted to different inter-chainsaw separations. The pinched brushwood bundle is sawed into bundle sections defined by the distance between the two or more chainsaws. In other embodiments the grappling claw may be fitted with at least one rotating disc blade to form a rotating saw grappling claw, wherein the at least one rotating disc blade may incorporate two or more rotating disc blades. The clamping action conveyed by either the chainsaw grappling claw or the rotating saw grappling claw stabilizes the grappled brushwood and allows smooth and efficient sawing action to be conveyed by the chainsaws or rotating disc blade saws.

Other embodiments of the on-site brushwood processing system includes a trailer with dimensions and weight amenable for hauling to and from forestry sites having access by narrow, tight switchback roads. The trailer is a short bed trailer having a rear gull-wing door. The trailer receives the narrowly cut bundles from the chainsaw grappling claw. The rear gull-wing door closes the loaded and compacted brushwood for removal from the logging site. The compacted brushwood removed from the logging site has the density and dryness amenable as a combustible fuel source for thermoelectric plants, or for enzymatic digestion to produce biofuels for combustion in vehicles. The trailer equipped with the gull wing door provides for easy dumping of the trailer-hauled and densely stacked brushwood that is sufficiently fluidized to amenably enable rapid sliding from the trailer.

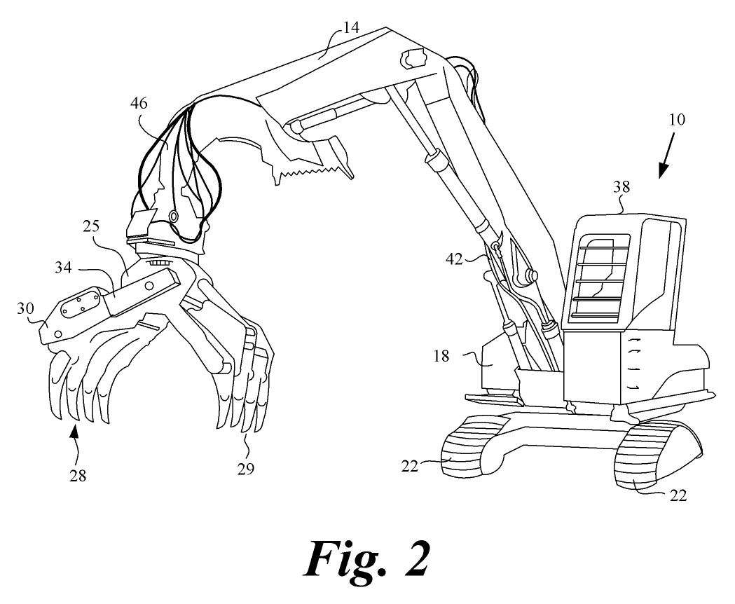

FIGS. 2-14 below illustrate particular embodiments of systems and methods for energy-efficient on-site processing of forestry brushwood and waste wood related debris.

In general, the figures illustrate systems and devices for compacting brushwood at a forestry site. The compacted brushwood provides meets and exceeds a density threshold to economically make feasible brushwood removal from remotely located forestry sites.

In one system embodiment for processing brushwood includes a chainsaw grappling claw that is operable by a machine. The machine may be forestry machine of a tractor-type equipment configuration, similar to a Caterpillar model 324D FM forestry machine. The chainsaw grappling claw may be deployable from a boom and be rotatable about the longitudinal axis of the boom. The chainsaw grappling claw includes at least one pivotable chainsaw attached to the side of or adjacent to the chainsaw grappling claw. The machine pivots the chainsaw grappling claw to a pile of brushwood and collects a bundle of the brushwood, pinches and holds it securely, and keeps the bundle in position to allow the pivotable chainsaw to rotate in relation to the pinched chainsaw grappling claw to cut the brushwood into at least one section smaller than the bundle of pinched brushwood.

Embodiments described herein also include a system for processing brushwood that includes a machine having a chainsaw grappling claw. The chainsaw grappling claw is operable by the machine in which the chainsaw grappling claw is fitted with at least one pivotable chainsaw attached to the side of the chainsaw grappling claw. The chainsaw grappling claw collects a brushwood bundle, pinches it and holds it to allow the at least one pivotable chainsaw to rotate and cut the brushwood bundle into brushwood sections. The at least one pivotable chainsaw is stowable in a sheath and deployable from the sheath to cut the brushwood bundle. In other embodiments the at least one pivotable chainsaw includes two chains saws pivotably mounted on each side of the chainsaw grappling claw in which the two chains are substantially parallel to each other. The substantially parallel arranged chainsaws pivot and cut the brushwood bundle substantially perpendicular to the axis of the brushwood bundle held by or within the chainsaw grappling claw. The machine that deploys the chainsaw grappling claw may be deployable from a vehicle. The system for processing brushwood may also include a trailer to receive the brushwood sections released by the chainsaw grappling claw. The trailer may then be removed from the forestry site to haul away the efficiently stacked and compacted brushwood.

Other embodiments described herein include a system for processing brushwood that includes a machine having a chainsaw grappling claw. The chainsaw grappling claw is operable by the machine in which the chainsaw grappling claw includes a first pivotable chainsaw attached to a first side of the chainsaw grappling claw and a second pivotable chainsaw attached to a second side of the chainsaw grappling claw. The machine operated chainsaw grappling claw collects a brushwood bundle, pinches it and holds it to allow the first and second pivotable chainsaws to rotate and cut the brushwood bundle into brushwood sections. Similarly, the first and the second chainsaws are stowed in sheaths and deploy from the sheaths to cut the brushwood bundle wherein the first chainsaw is substantially parallel to the second chainsaw. The first chainsaw may counter-rotates relative to the second chainsaw, or co-rotate in the same direction relative to the second chainsaw. Yet other embodiments provide for the first chainsaw extending from the first side to vary the cutting distance between the first and second chainsaws, or alternatively, the second chainsaw extending from the second side to vary the cutting distance between the first and second chainsaws. Similarly, both the first chainsaw and the second chainsaw may extend from the respective first and second sides to vary the cutting distance between the first and second chainsaws. In this alternate embodiment, the system may include a trailer to receive the brushwood sections released by the chainsaw grappling claw. The brushwood sections released by the grapping claw may include three brushwood sections—a first section released or falling away from the cutting action from the exterior of the first chainsaw, a second section released or falling away from the exterior of the second chainsaw, and a middle third section released from the opening grapping claw. The trailer that hauls away the efficiently stacked and compacted brushwood may have a length suitable to navigate the tight switchback roads common to forestry sites. In other situations, larger or longer trailers may be used where the roads do not have tight turning radiuses, thereby increasing the per haul loading removal of high density packed brushwood.

Other embodiments describe a chainsaw grappling claw that may be adapted to existing forestry machines. The chainsaw grappling claw includes a pivotable chainsaw attached to a side of the a chainsaw grappling claw, wherein the chainsaw grappling claw collects a brushwood bundle, pinches it and holds it to allow pivotable chainsaw to rotate and cut the brushwood bundle into brushwood sections. The chainsaw grappling claw may have its pivotable chainsaw stowable in and deployable from a sheath.

In another embodiment for compacting brushwood at a forestry site, the chainsaw grappling claw may include two chainsaws pivotably mounted on each side of the chainsaw grappling claw. Both chainsaws then pivotable rotate substantially perpendicular along the lengthwise axis of the pinched and chainsaw grappling claw-held wood bundle to cut the wood bundle along two saw lines, one saw line for each chainsaw. The two chainsaws are substantially parallel to each other and have a cutting axis that may be substantially perpendicular to the lengthwise axis of the pinched and chainsaw grappling claw-held wood bundle.

This two-chainsaw embodiment provides three sections; two end sections and a middle section substantially defined by the distance between the rotating chainsaws. Each section is smaller than the originally held brushwood bundle and thus can be more compactly stacked in a trailer for hauling away from the logging site. In other embodiments the chainsaws may be adjusted to have varying inter-chainsaw distances, allowing for different cut lengths of the middle section of the brushwood bundles.

The rotating chainsaws of the single and double chainsaw embodiment may be sheathed in a stowed state, whereupon they rotate away from the sheath during chainsaw operation. In other embodiments, the sheaths may rotate away from the chainsaws.

In another alternate embodiment illustrated by the figures describes a system for removing brushwood from a forestry site. The system includes a forestry machine having a chainsaw grappling claw operable by a machine which may be mounted on a vehicle, and include at least one, and two pivotable chainsaws on each side of the chainsaw grappling claw. The alternate system embodiment includes a trailer transportable by a vehicle to and from the forestry site. The vehicle may include a gull-wing door. The chainsaw grappling claws collects a bundle of brushwood, pinches and holds it, the pivotable chainsaw rotates and cuts the brushwood into at least one section smaller than the bundle of brushwood, the chainsaw grappling claw deposits the cut brushwood onto the trailer, the gull-wing door is closed to secure the brushwood, and the trailer is hauled from the forestry site by the vehicle. In another alternate embodiment, the gull-wing door may be deployable or pivotable from the rear of the trailer. The gull-wing door provides a way to easily dump the efficiently stacked and cut brushwood sections as the stacked brushwood sections possess a greater fluidity that is amenable to easy sliding from the tilting trailers as the compact stacking exhibits substantially less resistance to sliding off and from the tilting trailer. When the gull wing door clearly lifts away from the trailer, the rear trailer opening is freely exposed to provide an exiting conduit for efficiently stacked and densified brushwood to slide from the trailer.

FIG. 2 depicts a side perspective view of a sheathed chainsaw mounted on the side of a chainsaw grappling claw operable by a Caterpillar forestry machine (hereinafter modified forestry machine). A modified forestry machine 10 includes a chainsaw grappling claw 25 attached to an articulating crane 14 pivotably mounted to a base 18 that is moveable via tracks 22. Pivotably attached to the distal end of the articulating crane 14 is the chainsaw grappling claw 25. The chainsaw grappling claw 25 includes a first group of talons 28 that pivotably mesh with in clamping or grabbing fashion with a second group of talons 29. The chainsaw grappling claw 25 also includes a rotatable chainsaw assembly 34 in which the chainsaw (not shown) is enveloped by a sheath 34. The chainsaw assemblies 30 and 31 are shown mounted onto the external face of the first talon group 28 and the second talon group 29. The crane 14, base 18, chainsaw grappling claw 25 and chainsaw assembly 34 are operable from the cab 38 via hydraulic lines 42 and electrical lines 46.

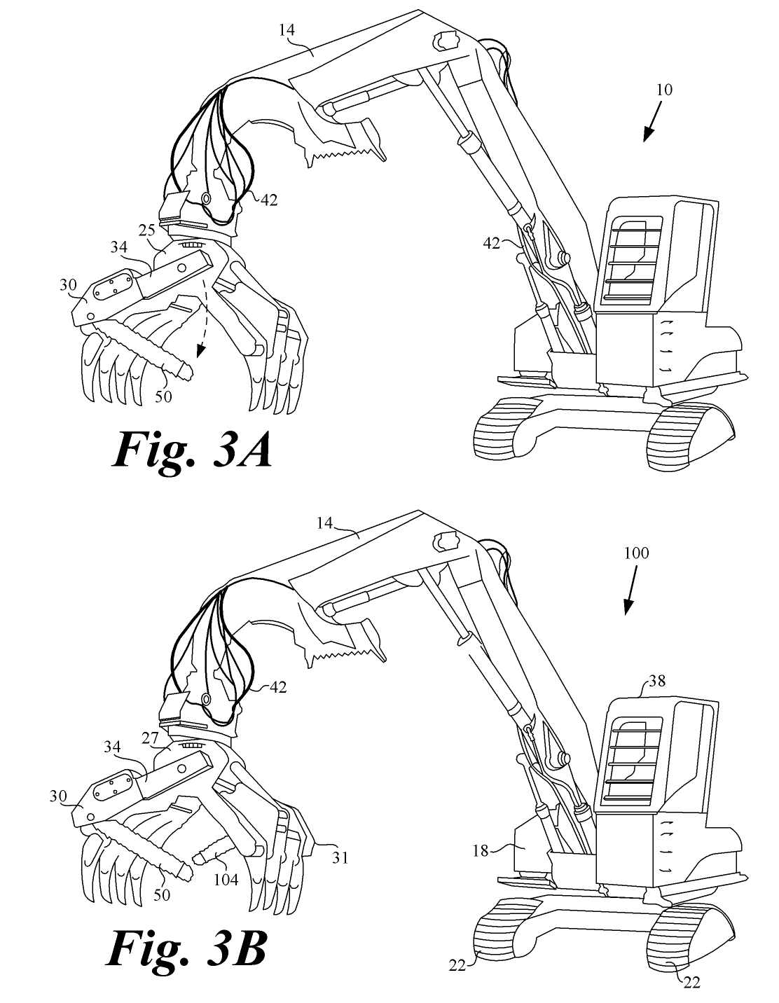

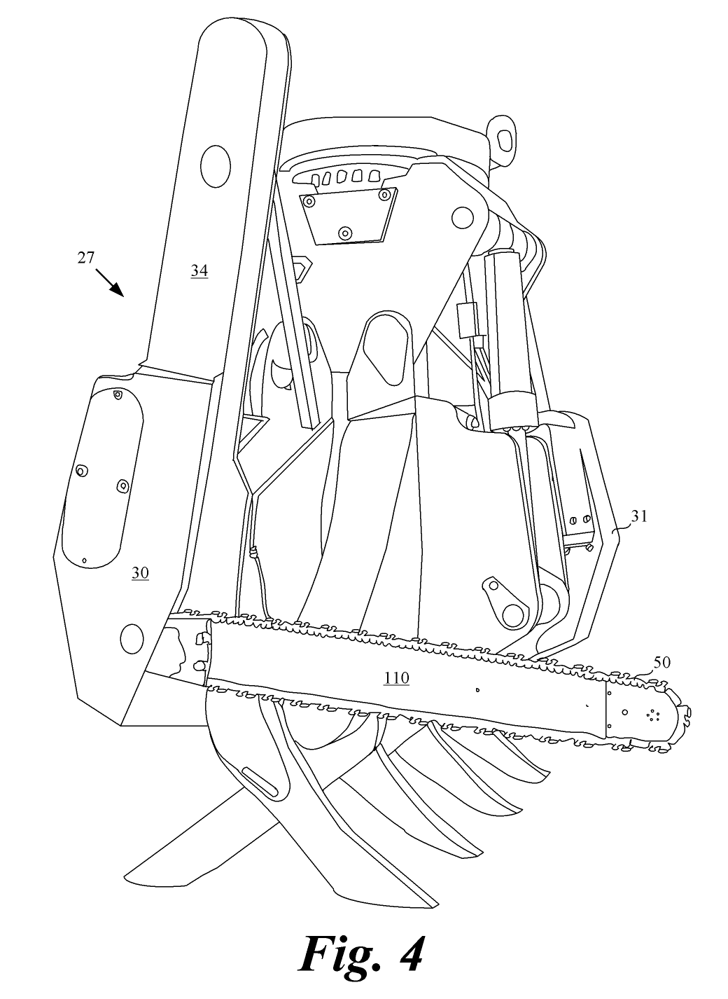

FIG. 3A depicts a side perspective view of an un-sheathed or deployed chainsaw mounted on the side of the chainsaw grappling claw 25 operable by the modified forestry machine 10. A chainsaw 50 is shown deployed clockwise from its sheath 34 along the exterior face of the first talon group 28 on the chainsaw grappling claw 25 operated by the forestry machine 10.

FIG. 3B depicts an alternate embodiment of the modified forestry machine 10 of FIG. 3A having two un-sheathed or deployed chainsaws on opposing sides of a chainsaw grappling claw 27. Here a modified forestry machine 100 includes substantially the same components of the modified forestry machine 10, but also includes a second chainsaw 110 that is deployed from its rotatable chainsaw assembly 34 (not shown) pivotably mounted from the opposing side of the chainsaw grappling claw 27 on the external face of the second talon group 30. The second chainsaw 110 is deployed in clockwise fashion as is the chainsaw 50 deploys from its sheath 34. Other alternate embodiments may have the chainsaw assemblies 30 mounted in such a manner that the respective chainsaws 50 and 104 deploy from their sheaths 34 in a counterclockwise manner. Mounting embodiments of the chainsaw assemblies may provide for the respective chainsaws 50 and 104 to both deploy clockwise, both deploy counterclockwise, or one to deploy clockwise and the other to deploy counterclockwise.

FIG. 4 depicts a side perspective view of the chainsaw grappling claw 27 with an unsheathed chainsaw 50 positioned to grasp a bundle of forestry brushwood.

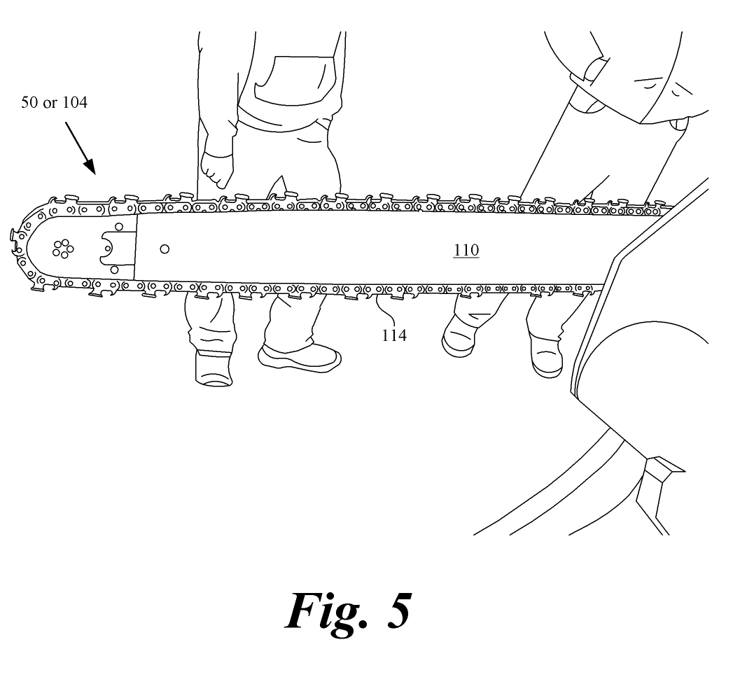

FIG. 5 is a side view depicting a portion of the unsheathed chainsaw 50 or 104. A chainsaw support 110 serves provides a perimeter track for the cutting blade chain 114. The size of the chainsaw 10 or 104 may be any length to accommodate typical slash piles found at forestry sites, and may be commonly have lengths ranging between 3 and 12 feet. Here outlines of workers are shown to gauge chainsaw dimensions.

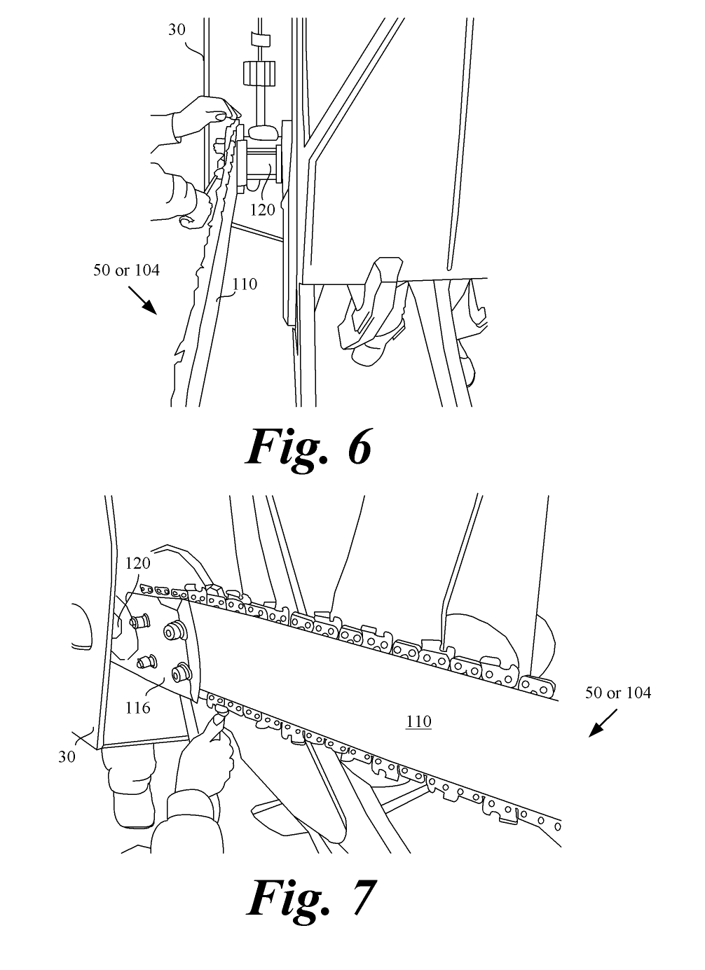

FIG. 6 depicts a front perspective view of a portion of an unsheathed chainsaw undergoing maintenance. The chainsaw 50 or 104 is mounted to a chainsaw axle 120 from which the chainsaw rotates.

FIG. 7 depicts a side perspective view of a portion of an unsheathed chainsaw 50 or 104 undergoing maintenance. A securing plate 116 is shown adjacent to the axle 120.

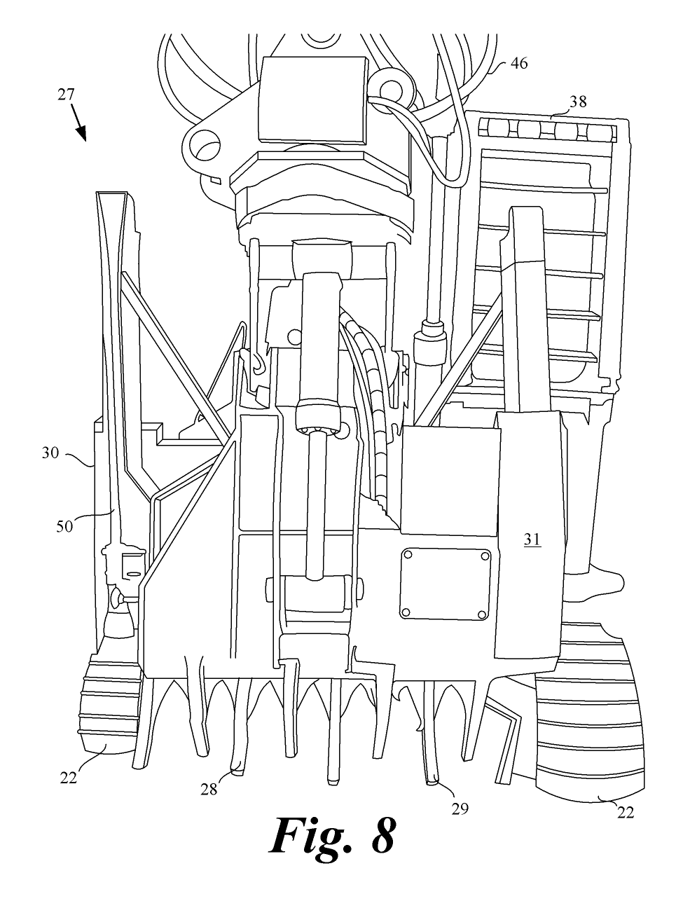

FIG. 8 depicts a front view of the chainsaw grappling claw 27 with sheathes 30 and 31 that house chainsaws 50 and 104 in relation to adjacent drive cage 38 of modified forestry machine 100.

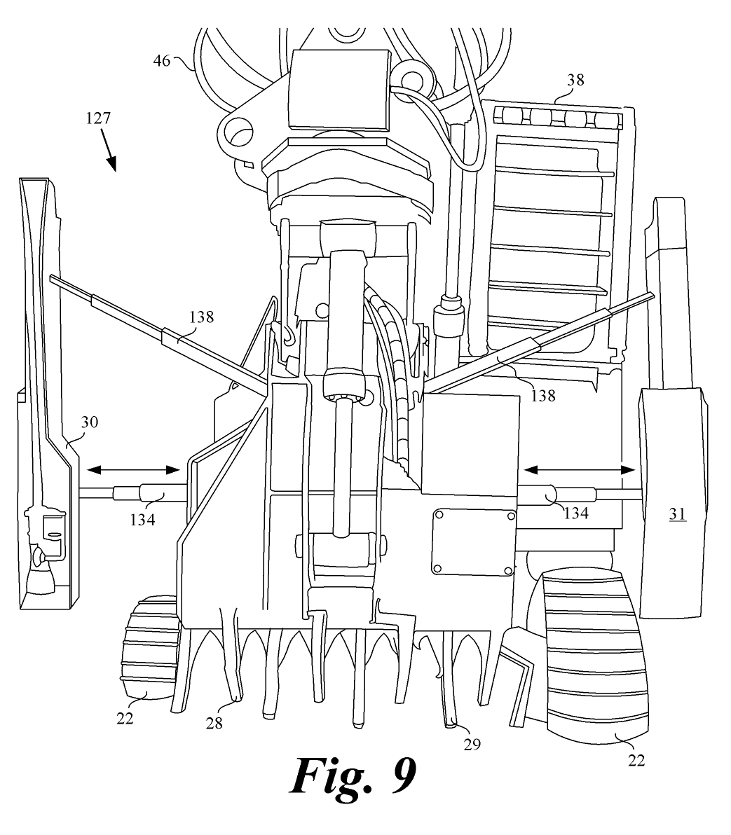

FIG. 9 depicts a front view of another embodiment of a chainsaw grappling claw 127 fitted with sheaths 30 and 31 housing chainsaws 50 and 104 extended to accommodate different length brushwood cuts in relation to the adjacent drive cage 38. Horizontal tubular extension 134 and slanted tubular extension 138 adjustably deploy the chainsaw assemblies 30 and 31 to cut grasped brushwood bundles at lengths defined by the distance between the chainsaws 50 and 104 respectively house in chainsaw assemblies 30 and 31.

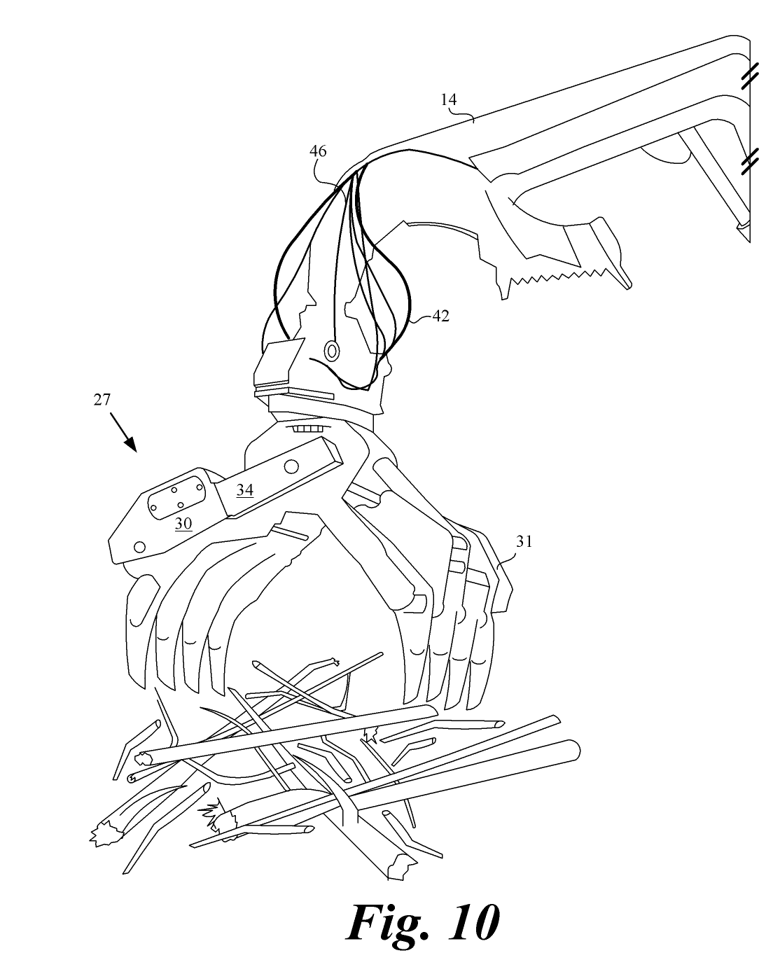

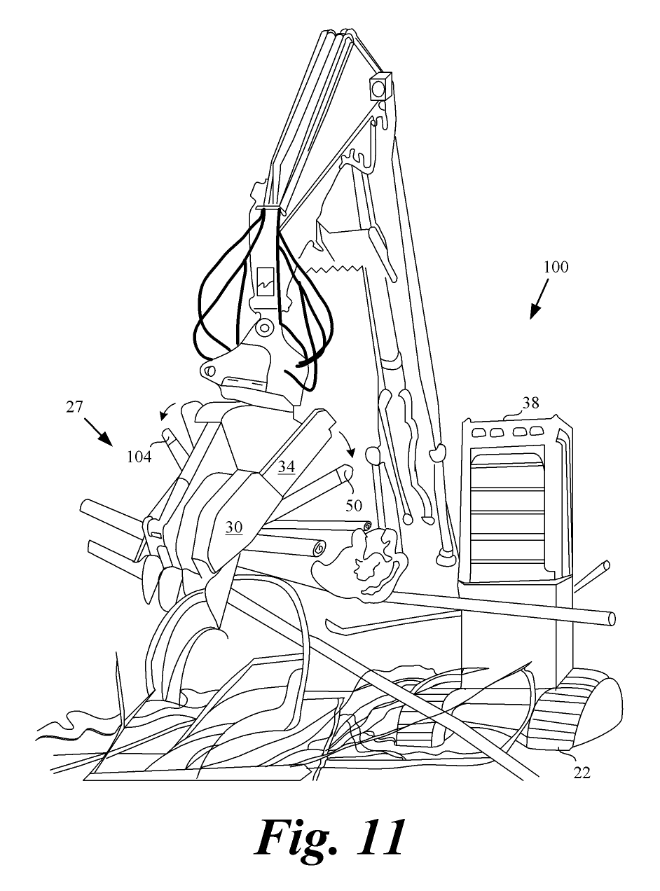

FIG. 10 depicts a side perspective view of a deployed chainsaw grappling claw 27 with sheaths 30 and 31 housing chainsaws 50 and 104 being positioned to grasp a bundle of forestry brushwood.

FIG. 11 depicts a side perspective view of a deployed chainsaw grappling claw 27 operated by modified forestry machine 100 with unsheathed chainsaws 50 and 104 being deployed onto to grappled bundle of forestry brushwood. A chainsaw sawing operation in progress in shown in which chainsaws are mounted on each side of the grappling claw and counter rotate relative to each other to establish compensating torque forces applied onto the pinched wood bundle. In this example the grasped brushwood bundle includes a brushwood piece having substantially larger diameter than adjacent brushwood pieces.

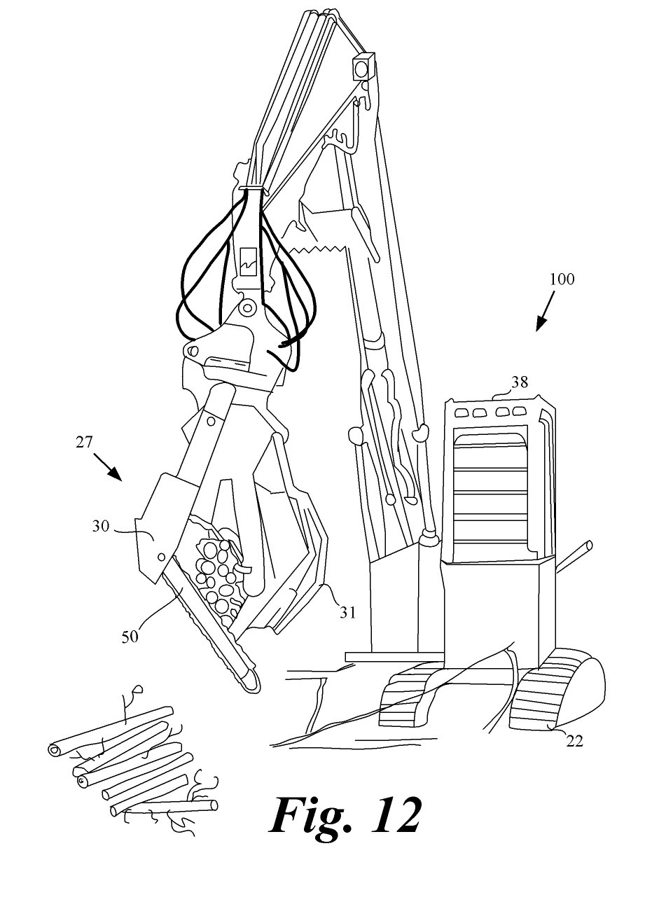

FIG. 12 depicts a side perspective view of a deployed chainsaw grappling claw 27 with the unsheathed chainsaw 50 deployed to reveal a cut grappled bundle of forestry brushwood. The cut brushwood bundle is shown fallen away from the still grasped brushwood bundle having brushwood pieces of substantially similar diameters.

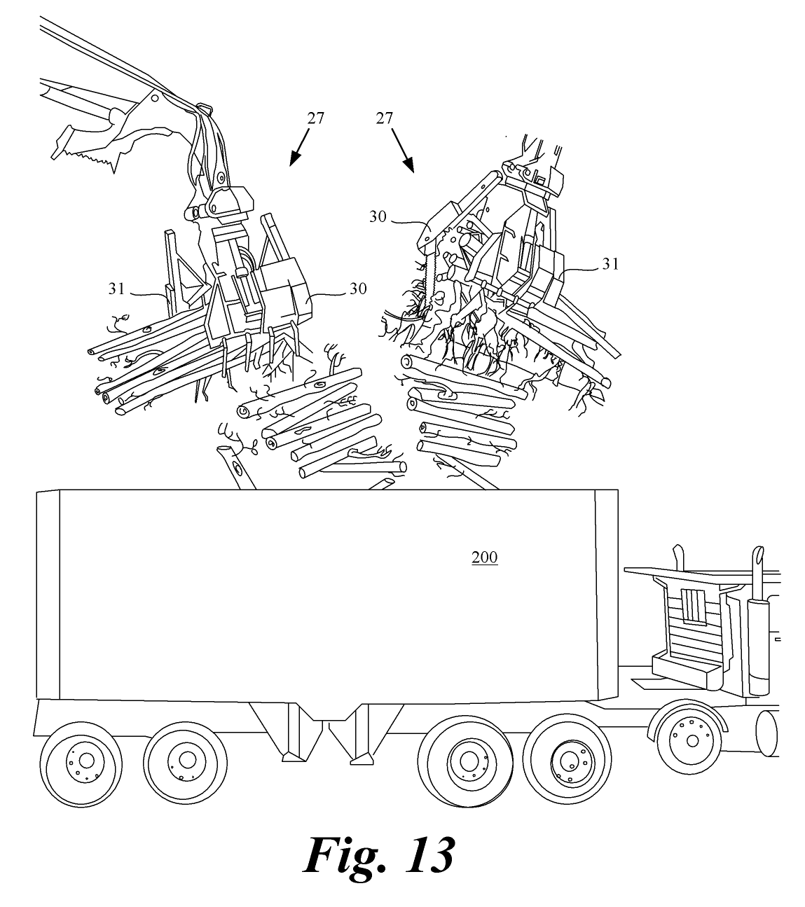

FIG. 13 depicts a side and side perspective views of deployed chainsaw grappling claws 27 with deploying and deployed unsheathed chainsaws positioned to drop cut brushwood bundles into a forestry trailer 200 in an on-site loading operation. The loading operation of the cut brushwood from the modified forestry machine occurs into a lightweight trailer 200 having a length suitable to navigate the sharp switchback turns commonly encountered in forestry operations. The lightweight trailer 200 may be configured for tight radius turning to accommodate the switchback turns common in mountainous forest regions. The lightweight trailer 200 may include a gull-wing door (not shown) deployable from the rear of the trailer such that opening and closing of the trailer occurs at the rear of the trailer.

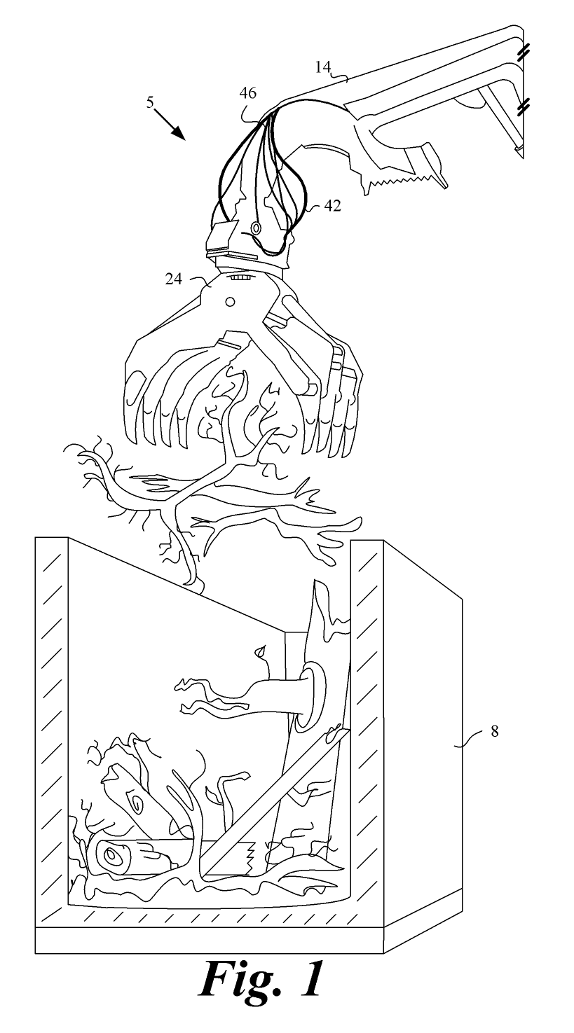

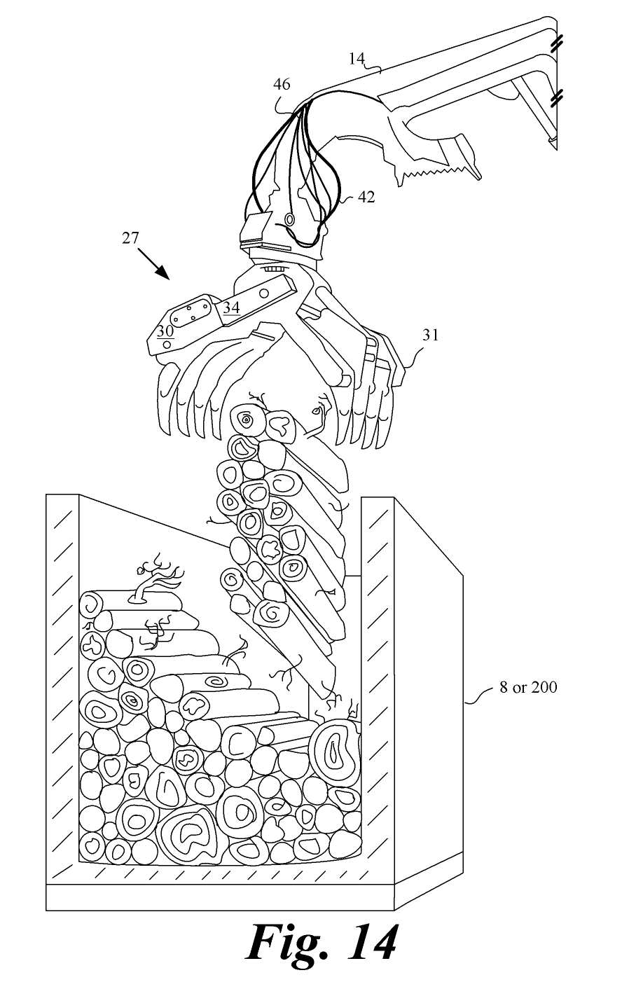

FIG. 14 depicts a side perspective and cross-sectional view of deployed chainsaw grappling claw 27 with sheathed chainsaws 50 and 104 positioned and releasing cut brushwood bundles into the forestry trailer 200. The forestry trailer 200 is shown in cross section and depicts a substantially compacted forestry bundles for efficient removal or hauling from the forestry site. Alternatively, longer bed trailers, such as the forestry trailer 8 depicted in FIG. 1, may be used at forestry or other sites for efficient compaction of cut brushwood sections receiving cut brushwood bundles released from any or all forestry machines modified or equipped with the grappling claws 25, 27, or 127, in which the longer bed trailer 8 have access to forestry sites in which switchback roads are not present to hinder access by these longer bed trailers to the forestry or other site.

While the preferred embodiment of the invention has been illustrated and described, as noted above, many changes can be made without departing from the spirit and scope of the invention. For example, embodiments may not be limited to single or dual chainsaws that rotate about the grappling axis of the grappling or pinching claw. A third chainsaw may be installed in the middle of the grappling claw that is substantially parallel to the side mounted chainsaws adjustably attached to the grappling claw. Other embodiments a dual chainsaw grappling claw, each chainsaw grappling claw equipped with side chainsaws and/or with an internal chainsaw, so that multiple subsections of larger pinched wood bundles may be rapidly cut to product higher-density processed brushwood. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A system for processing brushwood comprising:
a machine having a grappling claw operable by the machine; and
at least one pivotable chainsaw attached adjacent to the grappling claw;
wherein the grappling claw collects a brushwood bundle, pinches it and securely holds it to allow the at least one pivotable chainsaw to rotate and cut the brushwood bundle into brushwood sections.

2. The system of claim 1, wherein the at least one pivotable chainsaw is stowed in a sheath and deploys from the sheath to cut the brushwood bundle.

3. The system of claim 1, wherein the at least one pivotable chainsaw includes two chains saws pivotably mounted on each side of the grappling claw.

4. The system of claim 2, wherein the two chains saws are substantially parallel to each other.

5. The system of claim 1, wherein the at least one pivotable chainsaw cuts the brushwood bundle substantially perpendicular to the axis of the brushwood bundle held by grappling claw.

6. The system of claim 1, wherein the machine is deployable from a vehicle.

7. The system of claim 1, further including a trailer to receive the brushwood sections released by the grappling claw.

8. A system for processing brushwood comprising:
a machine having a grappling claw operable by the machine; and
a first pivotable chainsaw attached to a first side of the grappling claw;
a second pivotable chainsaw attached to a second side of the grappling claw;
wherein the grappling claw collects a brushwood bundle, pinches it and holds it to allow the first and second pivotable chainsaws to rotate and cut the brushwood bundle into brushwood sections.

9. The system of claim 8, wherein the first and the second chainsaws are stowed in sheaths and deploy from the sheaths to cut the brushwood bundle.

10. The system of claim 8, wherein the first chainsaw is substantially parallel to the second chainsaw.

11. The system of claim 8, wherein the first chainsaw counter-rotates relative to the second chainsaw.

12. The system of claim 8, wherein the first chainsaw co-rotates relative to the second chainsaw.

13. The system of claim 8, wherein the first chainsaw extends from the first side to vary the cutting distance between the first and second chainsaws.

14. The system of claim 8, wherein the second chainsaw extends from the second side to vary the cutting distance between the first and second chainsaws.

15. The system of claim 8, wherein the first chainsaw and the second chainsaw extends from the first and second sides to vary the cutting distance between the first and second chainsaws.

16. The system of claim 8, further including a trailer to receive the brushwood sections released by the grappling claw.

17. A grappling claw operable by a forestry machine comprising:
a pivotable chainsaw attached to a side of the grappling claw,
wherein the grappling claw collects a brushwood bundle, pinches it and holds it to allow pivotable chainsaw to rotate and cut the brushwood bundle into brushwood sections.

18. The grappling claw of claim 17, wherein the pivotable chainsaw is stowed in a sheath and deployed from the sheath.

19. A grappling claw operable by a forestry machine comprising:
a first pivotable chainsaw attached to a first side of the grappling claw,
a second pivotable chainsaw attached to a second side of the grappling claw;
wherein the grappling claws collects a brushwood bundle, pinches and holds it, and the first and second pivotable chainsaws rotates and cuts the brushwood bundle into brushwood sections.

20. The grappling claw of claim 19, wherein the first and second pivotable chainsaws are stowed in sheaths and deployed from the sheaths.

21. The grappling claw of claim 19, wherein the distance between the first and second pivotable chainsaws is adjustable.
